(19) United States
(12) Patent Application Publication
(10) Pub. No.: US 2026/0285073 A1
(43) Pub. Date: Sep. 24, 2026

(54) IMAGE FORMING APPARATUS

(71) Applicant: FUJIFILM Business Innovation Corp., Tokyo (JP)

(72) Inventors: Kazunari ISHII, Kanagawa (JP); Tatsuro MATSUOKA, Kanagawa (JP); Yuka NOMURA, Kanagawa (JP); Maho ITAKURA, Kanagawa (JP); Natsuki OGAWA, Kanagawa (JP); Narumi NAKAYA, Kanagawa (JP)

(73) Assignee: FUJIFILM Business Innovation Corp., Tokyo (JP)

(21) Appl. No.: 19/261,979

(22) Filed: Jul. 7, 2025

(30) Foreign Application Priority Data
Mar. 24, 2025 (JP) 2025-048804

(51) Int. Cl. B41J 29/377; B41J 11/00; G03G 15/00; G03G 21/20

(52) U.S. Cl. CPC B41J 29/377; B41J 11/0085; G03G 15/6529; G03G 21/206

(57) ABSTRACT

An image forming apparatus includes: a transport member that has a transport surface on which paper on which an image forming material is placed is transported and a surface opposite to the transport surface; a blowing unit that blows cooling air toward the paper being transported on the transport surface of the transport member; a receiving member that is located on a side of the opposite surface of the transport member and has a receiving surface for receiving the transport member; and a suction unit that sucks the transport member in a direction of the receiving member by an action of a negative pressure via a through-hole penetrating the receiving member from the receiving surface of the receiving member.

### CROSS-REFERENCE TO RELATED APPLICATIONS

This application is based on and claims priority under 35 USC 119 from Japanese Patent Application No. 2025-048804 filed Mar. 24, 2025.

### BACKGROUND

### (i) Technical Field

The present invention relates to an image forming apparatus.

### (ii) Related Art

For example, JP1999-15308A discloses an image forming apparatus including a fixing device that fixes a toner image on a sheet using a thermal fixing method and a cooling device that cools the sheet discharged from the fixing device while transporting the sheet using a cooling roller. The image forming apparatus has a duct that is disposed above the cooling roller of the cooling device and circulates air for cooling the cooling roller. In addition, an intake port and an exhaust port of the duct are provided outside a transport path of the sheet.

### SUMMARY

Here, in a case where air is blown to paper having an image forming material placed thereon to cool the paper during transport of the paper by a transport member, the transport member may deviate in a direction intersecting a transport direction due to the blowing of the air. The occurrence of the deviation can be suppressed by sucking the transport member to a receiving member that receives the transport member.

Aspects of non-limiting embodiments of the present disclosure relate to an image forming apparatus that suppresses occurrence of deviation of a transport member, as compared to a case where a configuration of sucking a transport member to a receiving member that receives the transport member is not provided.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: a transport member that has a transport surface on which paper on which an image forming material is placed is transported and a surface opposite to the transport surface; a blowing unit that blows cooling air toward the paper being transported on the transport surface of the transport member; a receiving member that is located on a side of the opposite surface of the transport member and has a receiving surface for receiving the transport member; and a suction unit that sucks the transport member in a direction of the receiving member by an action of a negative pressure via a through-hole penetrating the receiving member from the receiving surface of the receiving member.

### BRIEF DESCRIPTION OF THE DRAWINGS

Exemplary embodiment(s) of the present invention will be described in detail based on the following figures, wherein:

FIG. 1 is a diagram showing an image forming apparatus according to the present exemplary embodiment;

FIG. 2 is a diagram showing an example of a configuration of a paper transport section;

FIG. 3 is a plan view showing an example of a configuration of a heat sink;

FIGS. 4A to 4C are diagrams showing a blowing direction of a fan, in which FIG. 4A shows a first example, FIG. 4B shows a second example, and FIG. 4C shows a third example;

FIG. 5 is a diagram showing an example of a configuration of an image forming apparatus according to a first exemplary embodiment; and

FIG. 6 is a diagram showing an example of a configuration of an image forming apparatus according to a second exemplary embodiment.

### DETAILED DESCRIPTION

Hereinafter, an exemplary embodiment of the present invention will be described in detail with reference to the accompanying drawings.

### Schematic Configuration of Image Forming Apparatus

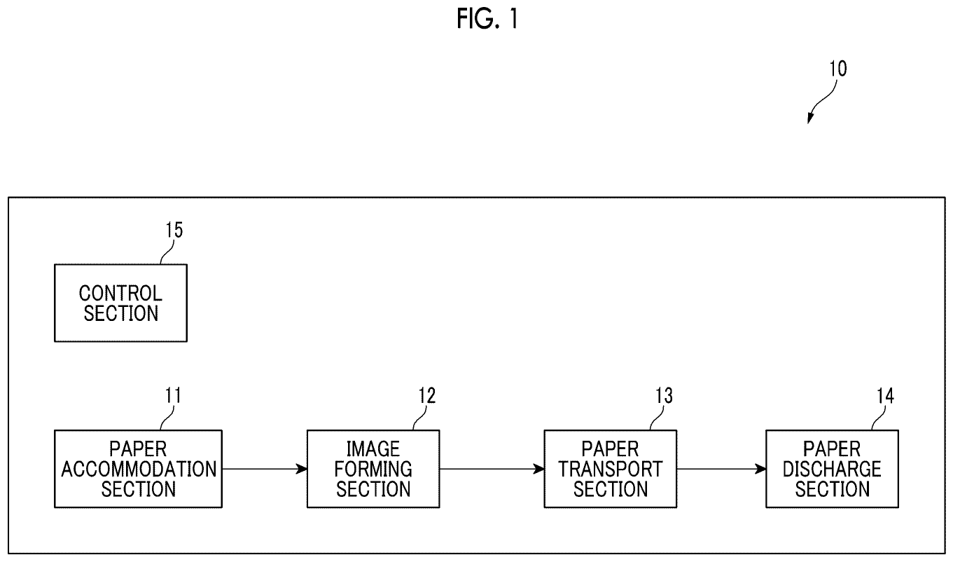

FIG. 1 is a diagram showing an image forming apparatus 10 according to the present exemplary embodiment.

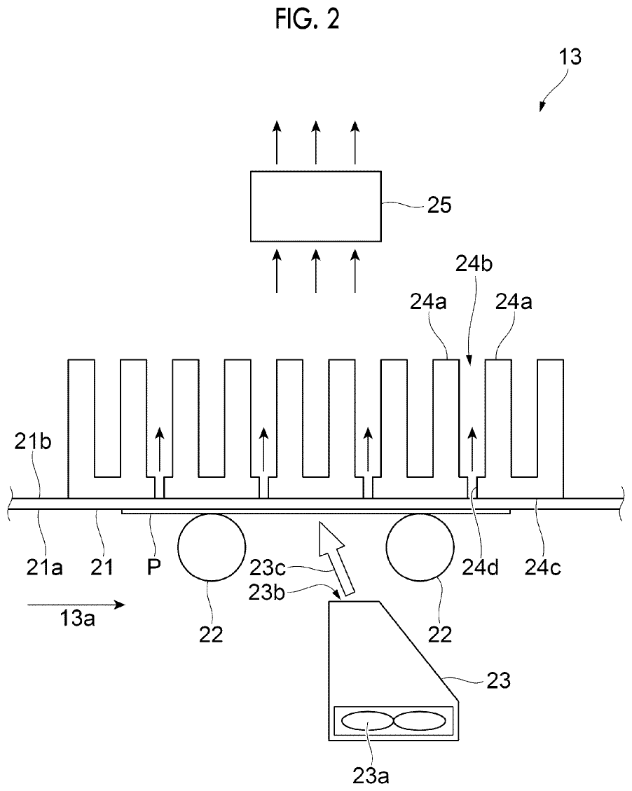

As shown in FIG. 1, the image forming apparatus 10 forms an image on a sheet as a printing medium. The image forming apparatus 10 includes a paper accommodation section 11 that accommodates paper P (for example, see FIG. 2) as a sheet, an image forming section 12 that forms an image on the paper P, and a paper transport section 13 that transports the paper P having the image formed thereon. In addition, the image forming apparatus 10 includes a paper discharge section 14 that discharges the paper P transported by the paper transport section 13 to the outside of the apparatus and a control section 15 that controls an operation of the image forming apparatus 10.

The paper accommodation section 11 of the image forming apparatus 10 accommodates the paper P having a predetermined size. The paper P in the paper accommodation section 11 is fed to the image forming section 12 at a timing when an image is formed by the image forming section 12. In addition, a configuration in which a plurality of paper accommodation sections 11 are provided may be adopted such that sheets of paper P having different sizes and types can be accommodated.

The image forming section 12 forms an image on the paper P transported from the paper accommodation section 11. The image forming section 12 performs digital printing based on print data. More specifically, the image forming section 12 forms an image on the paper P using an electrophotographic method or an ink-jet method. The image forming section 12 can also be referred to as an image creating section.

The electrophotographic method described herein is a printing method that attaches powdered toner to a charged drum to form an image and transfers the image to the paper P, and the image transferred to the paper P is fixed by heat or pressure. In addition, the ink-jet method described herein is a printing method that applies heat or pressure to an ink and directly sprays the ink from nozzles onto the paper P to form an image.

The paper transport section 13 is disposed on the downstream side of the image forming section 12 in a paper transport direction. The paper transport section 13 transports the paper P on which the image has been formed by the image forming section 12. The paper transport section 13 may consist of, for example, a pair of rollers and the pair of rollers may be rotated to transport the paper.

The paper discharge section 14 discharges the paper P transported by the paper transport section 13 to the outside of the apparatus. The paper discharge section 14 in the example shown in the drawings may consist of, for example, a pair of rollers, and the paper P may be discharged from the image forming apparatus 10 as the pair of rollers are rotated.

In addition, the paper discharge section 14 may have a function of executing post-processing, such as a binding process or a folding process, on the paper P to be discharged.

The control section 15 includes a CPU that executes a program and controls the operation of each component provided in the image forming apparatus 10. More specifically, the control section 15 controls the digital printing in the image forming section 12. In addition, the control section 15 drives driving sources, such as various motors, to control the transport of the paper P from the paper accommodation section 11 to the paper transport section 13.

Here, the operation of the image forming apparatus 10 will be described. In the image forming apparatus 10, as the control section 15 outputs an instruction signal, the paper P is fed one by one from the paper accommodation section 11. Then, after an image is formed on the paper P by the image forming section 12, the paper P is transported by the paper transport section 13. Then, the paper P is discharged by the paper discharge section 14.

### Example of Configuration of Paper Transport Section

Next, an example of a configuration of the paper transport section 13 will be described.

FIG. 2 is a diagram showing an example of the configuration of the paper transport section 13. In addition, FIG. 2 shows a case where the paper P is transported in a lateral direction or a right-left direction. However, the present invention is not limited thereto. For example, it is considered that the present invention is applied to a case where the paper P is transported in an up-down direction or a longitudinal direction, a case where the paper P is transported in an oblique direction, or the like.

As shown in FIG. 2, the paper transport section 13 includes a transport belt 21 that is rotatable in one direction. In addition, the paper transport section 13 includes a plurality of transport rollers 22 that are disposed on the side of one surface 21a of the transport belt 21 and a fan 23 that is disposed on the side of the one surface 21a of the transport belt 21.

Further, the paper transport section 13 includes a heat sink 24 that is disposed on the side of the other surface 21b of the transport belt 21 and a suction unit 25 that is disposed on the side of the other surface 21b of the transport belt 21.

The transport rollers 22, the fan 23, the heat sink 24, and the suction unit 25 are disposed at predetermined positions with respect to the transport belt 21.

The transport belt 21 is a belt-shaped member that is configured to be movable in a loop and is stretched by a plurality of tension members. In addition, the transport belt 21 is rotated in one direction by the driving force of the driving source. In FIG. 2, it is assumed that the transport belt 21 is driven in a transport direction 13a of the paper P represented by an arrow.

The transport belt 21 transports the paper P on the side of the one surface 21a. The one surface 21a described herein is a lower surface of the transport belt 21 in FIG. 2.

The transport belt 21 does not have any holes penetrating the transport belt 21 from the one surface 21a to the other surface 21b.

The plurality of transport rollers 22 are rotatably held and are disposed on the side of the one surface 21a of the transport belt 21 to face each other. Each of the plurality of transport rollers 22 is disposed at an interval from another adjacent transport roll.

Each of the plurality of transport rollers 22 is disposed on the side of the one surface 21a of the transport belt 21 to hold the transported paper P.

The fan 23 has a blade member 23a that receives a driving force to be rotated and a nozzle 23b that is an outlet of wind by the blade member 23a.

The blade member 23a is a so-called propeller having a plurality of blades. In addition to a case where the number of blade members 23a is one, an example in which a plurality of blade members 23a are arranged in a direction perpendicular to the plane of paper is considered.

The nozzle 23b is formed in a throttle shape whose opening area is smaller than an area in a case where the blade member 23a is rotated.

The fan 23 blows air from the nozzle 23b in a blowing direction 23c represented by an arrow. As described above, air is blown toward the one surface 21a of the transport belt 21. The blowing direction 23c described herein can also be referred to as a spraying direction.

Air is blown from the fan 23 to the paper P transported by the transport belt 21. Therefore, the paper P is cooled or dried by the fan 23 during the transport. That is, the image of the paper P is cooled or dried.

The operation timing of the fan 23 is controlled by the control section 15 (see FIG. 1).

Further, a modification example in which hot air or cold air is blown as the air from the fan 23 is also considered.

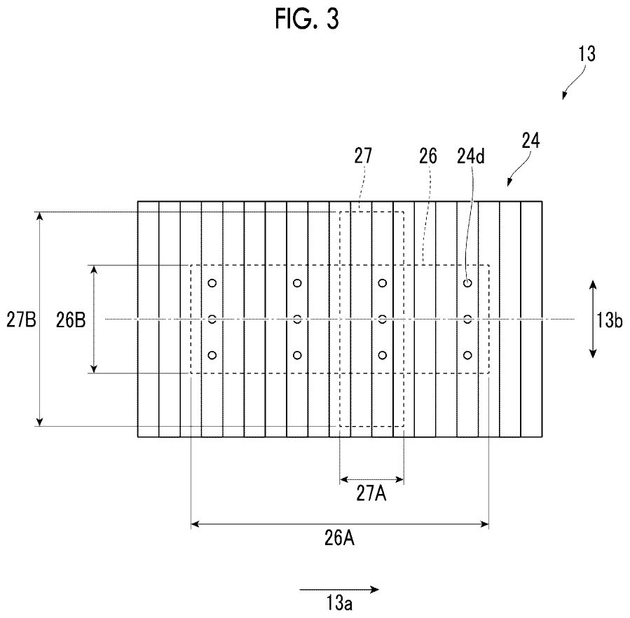

The heat sink 24 is a heat dissipation member that absorbs heat and dissipates the heat into the air and includes ribs 24a that extend upward and are formed along the same direction as the transport direction 13a to increase a surface area. The rib 24a extends in a direction (a direction perpendicular to the plane of paper in FIG. 2) intersecting with the transport direction 13a. The intersection direction described herein is the same direction as an intersection direction 13b (see FIG. 3) that will be described below.

A gap 24b is located between adjacent ribs 24a.

The heat sink 24 dissipates heat from the transport belt 21. The heat sink 24 is made of metal such as aluminum. However, a case where the heat sink 24 is made of a resin is also considered.

The heat sink 24 is disposed such that a heat absorbing surface 24c, which is a bottom surface, faces the other surface 21b of the transport belt 21. In addition, a plurality of through-holes 24d are formed in the heat sink 24.

The through-hole 24d penetrates the heat sink 24 from the heat absorbing surface 24c. More specifically, in the example of the configuration shown in FIG. 2, the through-hole 24d is provided in the gap 24b while avoiding the rib 24a. Since the through-hole 24d is located in the gap 24b between the ribs 24a, the through-hole 24d is easily formed, and an increase in the manufacturing cost of the heat sink 24 is suppressed. In addition, since the through-hole 24d is disposed in the gap 24b, a suction effect is enhanced as compared to a case where the through-hole 24d is disposed at a position other than the gap 24b.

Further, an example in which the through-hole 24d is provided to penetrate the rib 24a without avoiding the rib 24a is also considered. In this example, the penetration direction of the rib 24a is considered to be an up-down direction or an oblique direction.

Furthermore, in the example of the configuration shown in FIG. 2, the heat sink 24 in which the ribs 24a are formed is provided. However, the present invention is not limited thereto, and an example in which a flat plate (not shown) on which the ribs 24a are not formed is used is also considered. In the case of this example, the flat plate (not shown) does not have the ribs 24a and the gaps 24b, but has the heat absorbing surface 24c and the through-holes 24d.

The suction unit 25 is a device that sucks air by negative pressure on the side of the other surface 21b of the transport belt 21 and is configured as, for example, a suction pump or a suction fan. In a case where the suction unit 25 is operated, suction is performed from the through-holes 24d of the heat sink 24. The heat dissipation of the heat sink 24 is promoted by the flow of air due to the suction.

The suction unit 25 sucks the transport belt 21 in the direction of the heat sink 24 by the action of the negative pressure via the through-holes 24d of the heat sink 24.

More specifically, the transport belt 21 is sucked to the other surface 21b by the action of the negative pressure, and the other surface 21b is stuck to the heat absorbing surface 24c of the heat sink 24. The other surface 21b of the transport belt 21 is in a state in which the other surface 21b is in close contact with the heat absorbing surface 24c of the heat sink 24. Therefore, the behavior of the transport belt 21 moving to one side in the width direction (the direction perpendicular to the plane of paper in FIG. 2) in a case where the transport belt 21 is driven in the transport direction 13a is suppressed. That is, the meandering movement of the transport belt 21 or the paper P in the transport direction 13a during the transport is suppressed, and paper transportability can be maintained.

In addition, the absorption of heat from the transport belt 21 to the heat sink 24 is performed more efficiently than in a case where the suction unit 25 does not operate. The absorbed heat is also the heat transferred from the paper P to the transport belt 21. Therefore, the heat of the paper P or the heat of the image of the paper P is efficiently transferred to the heat sink 24.

As described above, the paper transport section 13 includes the fan 23 and the heat sink 24. In this sense, the paper transport section 13 has a function of cooling or drying the image of the paper P in a case where the paper P, on which the image has been formed by the image forming section 12, is transported (see FIG. 1).

As described above, in the paper transport section 13, the paper P is transported on the one surface 21a of the transport belt 21. During the transport of the paper P, cooling air is blown from the fan 23 toward the paper P.

Therefore, the paper P is pressed against the one surface 21a of the transport belt 21 and is cooled or dried.

In addition, in the paper transport section 13, the plurality of through-holes 24d are formed in the heat sink 24, and air on the other surface 21b of the transport belt 21 is sucked by the suction unit 25.

Since the other surface 21b of the transport belt 21 is stuck to the heat absorbing surface 24c of the heat sink 24, the transport by the transport belt 21 is stabilized. In addition, the heat of the paper P is quickly dissipated to the other surface 21b of the transport belt 21, and the cooling or drying of the paper P is promoted.

Here, the transport belt 21 is an example of a transport member. In addition, the one surface 21a of the transport belt 21 is an example of a transport surface, and the other surface 21b of the transport belt 21 is an example of an opposite surface. The paper P is an example of paper having an image forming material placed thereon.

The fan 23 is an example of a blowing unit.

The heat sink 24 is an example of a receiving member, the heat absorbing surface 24c of the heat sink 24 is an example of a receiving surface, and the through-hole 24d is an example of a through-hole penetrating the receiving member. In addition, the gap 24b of the heat sink 24 is an example of a thin portion.

### Heat Sink in Paper Transport Section

Next, the heat sink 24 in the paper transport section 13 will be described.

FIG. 3 is a plan view showing an example of a configuration of the heat sink 24.

As shown in FIG. 3, in a plan view, the through-holes 24d formed in the heat sink 24 are located in a suction region 26 that is a region in which the suction by the suction unit 25 (see FIG. 2) acts. The suction region 26 has a size of a length 26A in the transport direction 13a and a length 26B in the intersection direction 13b.

In addition, the suction region 26 is disposed such that a center line of the suction region 26 and a center line of the heat sink 24 overlap each other in the intersection direction 13b. The positions of the through-holes 24d in the suction region 26 are bilaterally symmetric and line-symmetric with respect to the intersection direction 13b. That is, the plurality of through-holes 24d in the suction region 26 are disposed to be symmetric with respect to the intersection direction 13b.

Therefore, a difference in the suction force of the suction unit 25 applied to the transport belt 21 (see FIG. 2) during the transport in the intersection direction 13b is reduced, which makes it possible to suppress the meandering of the transport belt 21.

The through-holes 24d in the suction region 26 is an example of a plurality of through-holes, and the intersection direction 13b is an example of a direction intersecting a direction in which the transport member transports the paper.

As shown in FIG. 3, in a plan view, a blowing region 27, which is a region to which air is blown, is narrowed by the nozzle 23b (see FIG. 2) in the transport direction 13a. More specifically, the blowing region 27 by the fan 23 (see FIG. 3) has a size of a length 27A in the transport direction 13a and a length 27B in the intersection direction 13b.

Here, the lengths of the suction region 26 and the blowing region 27 in the transport direction 13a are compared. The length 27A of the blowing region 27 is shorter than the length 26A of the suction region 26. The force of pressing the paper P against the transport belt 21 (see FIG. 2) in the blowing region 27 by the fan 23 (see FIG. 2) is secured by this configuration.

The suction region 26 is an example of a region in which a plurality of through-holes are located, and the transport direction 13a is an example of the direction in which the transport member transports the paper. In addition, the blowing region 27 is an example of a region of the transport surface to which air is blown by the blowing unit.

Further, the lengths of the suction region 26 and the blowing region 27 in the intersection direction 13b are compared. The length 27B of the blowing region 27 is longer than the length 26B of the suction region 26. Air can be blown from the fan 23 (see FIG. 2) to a wide range of the paper P by this configuration.

Furthermore, from another viewpoint, the length 26B of the suction region 26 is narrower or shorter than the length 27B of the blowing region 27. With this configuration, the resistance force caused by the close contact of the transport belt 21 with the heat sink 24 by the suction unit 25 is reduced, and an increase in driving force in a case where the transport belt 21 is driven is suppressed.

As shown in FIG. 3, the through-hole 24d in the heat sink 24 has a circular shape in a plan view. That is, the through-hole 24d has a circular cross section. More specifically, the through-hole 24d is not a polygon having corners such as a triangle. Therefore, the abrasion of the transport belt 21 in a case where the transport belt 21 comes into close contact with the heat sink 24 is suppressed.

In addition, FIG. 3 shows a case where the through-hole 24d has a circular shape. However, the present invention is not limited thereto. For example, the shape of the through-hole 24d may be an ellipse having an arc shape. In the case of the elliptical shape, the major axis may be along the transport direction 13a or may be along the intersection direction 13b.

### Blowing Direction of Fan

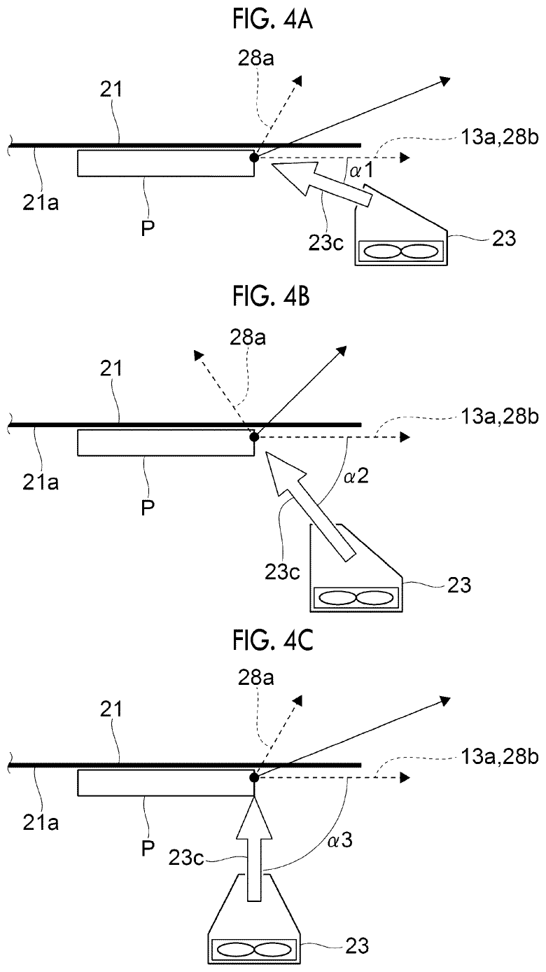

FIGS. 4A to 4C are diagrams showing the blowing direction 23c of the fan 23. FIG. 4A shows a first example, FIG. 4B shows a second example, and FIG. 4C shows a third example. In FIGS. 4A to 4C, the paper P is transported in the transport direction 13a by the one surface 21a of the transport belt 21. In FIGS. 4A to 4C, the transport belt 21 is broken, and a portion thereof is shown.

The blowing directions 23c of the fan 23 in FIGS. 4A to 4C are different from each other. In FIGS. 4A to 4C, it is assumed that the blowing direction 23c is defined by an intersection angle α which is an angle at which the blowing direction 23c intersects a line segment of a broken line indicating the transport direction 13a.

As described above, the blowing direction 23c is a direction different from the transport direction 13a, and blowing can be performed in a direction opposite to the transport direction 13a. According to this configuration, a transport speed of the paper P is taken into account, and it is possible to increase the speed of the air blown to the paper P and thus to enhance the cooling effect.

The air in the blowing direction 23c is an example of air in the opposite direction.

Here, since the blowing direction 23c is different from the transport direction 13a, a pressing force 28a and transport resistance 28b change depending on the intersection angle α.

The pressing force 28a described herein refers to the force with which the paper P is pressed against the one surface 21a of the transport belt 21 by the blowing of the fan 23. In addition, the transport resistance 28b refers to the degree to which the blowing of the fan 23 hinders the transport of the paper P in a case where the paper P is transported by the transport belt 21.

More specifically, the following relationship is established between the intersection angle α and the pressing force 28a: the pressing force 28a increases as the intersection angle α increases; and the pressing force 28a decreases as the intersection angle α decreases.

In addition, the pressing force 28a is as follows in a case where the blowing direction 23c is the same as the transport direction 13a and a case where the blowing direction 23c is different from the transport direction 13a. That is, the pressing force 28a in a case where the blowing direction 23c is different from the transport direction 13a is larger than that in a case where the blowing direction 23c is the same as the transport direction 13a.

In addition, in a case where the blowing direction 23c is different from the transport direction 13a, the relationship between the intersection angle α and the transport resistance 28b is as follows. That is, the transport resistance 28b decreases as the intersection angle α increases. In addition, the transport resistance 28b increases as the intersection angle α decreases.

A specific description will be made below.

In the first example shown in FIG. 4A, the blowing direction 23c of the fan 23 is a direction of an intersection angle α1. In the second example shown in FIG. 4B, the blowing direction 23c is a direction of an intersection angle α2. In the third example shown in FIG. 4C, the blowing direction 23c is a direction of an intersection angle α3.

The intersection angles α1, α2, and α3 are different from each other, and the inclination increases in this order. More specifically, the intersection angle α1 in FIG. 4A is an angle of less than 30 degrees. In addition, the intersection angle α2 in FIG. 4B is an angle of 30 degrees or more and 60 degrees or less, and the intersection angle α3 in FIG. 4C is an angle of more than 60 degrees.

Focusing on the pressing force 28a, the pressing force 28a is the smallest in the case of the intersection angle α1. The pressing force 28a increases in the order of the intersection angle α2 and the intersection angle α3. As the pressing force 28a is larger, the paper P is less likely to deviate from the transport belt 21. Therefore, from the viewpoint of the pressing force 28a, for example, the intersection angles α2 and α3 shown in FIGS. 4B and 4C are more preferable than the intersection angle α1 shown in FIG. 4A. Therefore, the adoption of the configuration in which the fan 23 blows air in the opposite direction at an intersection angle of 30 degrees or more makes it possible to ensure the pressing force 28a.

In addition, focusing on the transport resistance 28b, the transport resistance 28b is the largest in the case of the intersection angle α1. The transport resistance 28b decreases in the order of the intersection angle α2 and the intersection angle α3. As the transport resistance 28b is smaller, the transport by the transport belt 21 is more stable. Therefore, from the viewpoint of the transport resistance 28b, for example, the intersection angles α1 and α2 shown in FIGS. 4A and 4B are more preferable than the intersection angle α3 shown in FIG. 4C. Therefore, the adoption of the configuration in which the fan 23 blows air in the opposite direction at an intersection angle of 60 degrees or less makes it possible to suppress the transport resistance 28b.

Further, focusing on both the pressing force 28a and the transport resistance 28b, for example, the intersection angle α2 shown in FIG. 4B is more appropriate than the intersection angles α1 and α3 shown in FIGS. 4A and 4C. Therefore, the adoption of the configuration in which the fan 23 blows air in the opposite direction at an intersection angle of 30 degrees or more and 60 degrees or less makes it possible to suppress the transport resistance 28b while ensuring the pressing force 28a.

Next, an example of a configuration in a case where the image forming apparatus 10 according to the present exemplary embodiment is an electrophotographic type and an example of a configuration in a case where the image forming apparatus 10 according to the present exemplary embodiment is an ink-jet type will be described. The case where the image forming apparatus 10 is the electrophotographic type will be described as a first exemplary embodiment, and the case where the image forming apparatus 10 is the ink-jet type will be described as a second exemplary embodiment.

### First Exemplary Embodiment

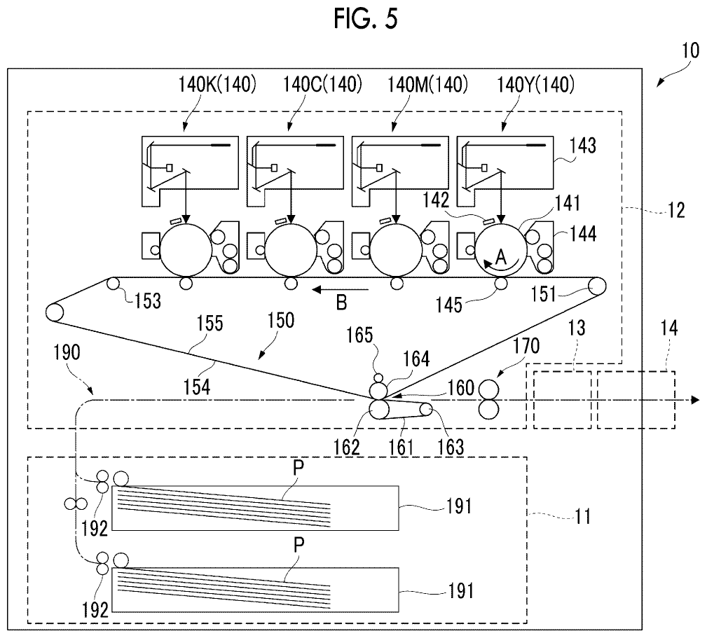

FIG. 5 is a diagram showing an example of a configuration of an image forming apparatus 10 according to the first exemplary embodiment.

As shown in FIG. 5, the image forming apparatus 10 according to the first exemplary embodiment is provided with the paper accommodation section 11, the image forming section 12, the paper transport section 13, and the paper discharge section 14, as in the case of the present exemplary embodiment (see FIG. 1). In addition, in FIG. 5, the control section 15 is not shown.

In a process of the electrophotographic type, a surface of a photoconductor drum charged by corona discharge is exposed to form an electrostatic latent image, the electrostatic latent image is developed with toner, and the toner is transferred to the paper P and is fixed using heat or pressure. The image forming section 12 that executes the process of the electrophotographic type will be described in more detail.

The image forming section 12 is provided with an image forming unit 140, an intermediate transfer belt 150, a secondary transfer unit 160, and a fixing unit 170.

In the first exemplary embodiment, four image forming units 140Y, 140M, 140C, and 140K are provided as the image forming unit 140 of the image forming section 12. The four image forming units 140Y, 140M, 140C, and 140K correspond to toners of four colors of yellow (Y), magenta (M), cyan (C), and black (K), respectively.

The image forming units 140Y, 140M, 140C, and 140K are arranged in a movement direction of the intermediate transfer belt 150 and form a toner image using the electrophotographic method.

Each of the image forming units 140Y, 140M, 140C, and 140K has a photoconductor drum 141, a charging unit 142, an exposure unit 143, a developing unit 144, and a primary transfer unit 145.

Each of the image forming units 140Y, 140M, 140C, and 140K forms a toner image of any of Y, M, C, or K and transfers the toner image onto the intermediate transfer belt 150. Therefore, a toner image in which the toner images of Y, M, C, and K have overlapped each other is formed on the intermediate transfer belt 150.

The photoconductor drum 141 is rotated in a direction of an arrow A at a predetermined speed. In addition, an electrostatic latent image is formed on a peripheral surface of the photoconductor drum 141.

The charging unit 142 charges the peripheral surface of the photoconductor drum 141 at a predetermined potential.

The exposure unit 143 irradiates the charged peripheral surface of the photoconductor drum 141 with light to form an electrostatic latent image on the peripheral surface of the photoconductor drum 141.

The developing unit 144 attaches a toner to the electrostatic latent image formed on the peripheral surface of the photoconductor drum 141 to form a toner image.

The primary transfer unit 145 transfers the toner image formed on the peripheral surface of the photoconductor drum 141 onto the intermediate transfer belt 150.

A voltage having a polarity opposite to a charging polarity of the toner is applied to the primary transfer unit 145. Therefore, the toner image formed on the peripheral surface of the photoconductor drum 141 is sequentially electrostatically attracted onto the intermediate transfer belt 150, and one overlapping color toner image is formed on the intermediate transfer belt 150.

The intermediate transfer belt 150 of the image forming section 12 is supported by a plurality of roll-shaped members. The intermediate transfer belt 150 is formed in an endless shape and is moved in a loop in a direction of an arrow B. In addition, the intermediate transfer belt 150 includes an outer peripheral surface 154 and an inner peripheral surface 155.

The intermediate transfer belt 150 is used to transport the toner image. In the present exemplary embodiment, the toner image is formed on the outer peripheral surface 154 of the intermediate transfer belt 150 and is transported to the secondary transfer unit 160 by the movement of the intermediate transfer belt 150.

In the present exemplary embodiment, a driving roller 151 that is driven by a motor (not shown) to drive the intermediate transfer belt 150 is provided as the roll-shaped member disposed inside the intermediate transfer belt 150. In addition, an idle roller 153 and a backup roller 164 that support the intermediate transfer belt 150 are provided as the roll-shaped members.

These roll-shaped members are rotatably provided and are pressed against the inner peripheral surface 155 of the intermediate transfer belt 150.

The secondary transfer unit 160 of the image forming section 12 includes a secondary transfer transport belt 161 that is disposed in contact with the outer peripheral surface 154 of the intermediate transfer belt 150. The secondary transfer transport belt 161 is a semi-conductive endless annular belt stretched by a driving roller (transfer roller) 162 made of metal, for example, SUS, and a driven roller 163 consisting of, for example, a rubber roller. The secondary transfer transport belt 161 is rotated at a predetermined speed by the driving roller 162 and is given a predetermined tension by the driving roller 162 and the driven roller 163.

In addition, the secondary transfer unit 160 is provided with the backup roller 164 that is disposed on the inner peripheral surface 155 of the intermediate transfer belt 150 and forms an opposite electrode of the secondary transfer transport belt 161. In addition, the secondary transfer unit 160 is provided with a metal power feeding roller 165 that applies a secondary transfer bias to the backup roller 164.

The secondary transfer unit 160 configured in this manner transfers the toner image transported to the secondary transfer unit 160 by the intermediate transfer belt 150 onto the transported paper P.

The fixing unit 170 of the image forming section 12 is disposed on the downstream side of the secondary transfer unit 160 in the transport direction of the paper P. The fixing unit 170 is provided with a fixing roller having a heating source and a pressurizing roller that is provided to face the fixing roller. The fixing unit 170 melts an unfixed toner image on the paper P and fixes the toner image on the paper P. Therefore, an image consisting of the toner images is formed on the paper P.

The paper accommodation section 11 according to the first exemplary embodiment will be described.

The paper accommodation section 11 has a drawer-type container 191 capable of accommodating a plurality of sheets of paper P having a predetermined size, type, and the like. The paper accommodation section 11 according to the first exemplary embodiment has two containers 191 that are arranged vertically.

In addition, the paper accommodation section 11 has a feeding device 192 that feeds the paper P accommodated in the container 191 one by one.

More specifically, a supply transport path 193 for transporting the paper P fed from the paper accommodation section 11 to the secondary transfer unit 160 is disposed between the paper accommodation section 11 and the image forming section 12.

Here, in the first exemplary embodiment shown in FIG. 5, the paper transport section 13 is disposed on the downstream side of the fixing unit 170. The paper transport section 13 cools the paper P on which the image has been fixed by the fixing unit 170 through pressure and heat. The configuration of the paper transport section 13 is the same as that described above with reference to FIG. 1, and the showing and description thereof will be omitted.

In addition, the paper discharge section 14 in the first exemplary embodiment is the same as that described above with reference to FIG. 1, and the showing and description thereof will be omitted.

In addition, the image forming apparatus 10 according to the first exemplary embodiment includes four image forming units 140Y, 140M, 140C, and 140K. However, the present invention is not limited thereto. For example, the adoption of a form in which the image forming apparatus 10 includes five or more image forming units corresponding to Y, M, C, K, and intermediate colors is considered. Further, the adoption of a form in which the image forming apparatus 10 includes one image forming unit and forms an image of only one color is considered.

### Second Exemplary Embodiment

Next, the second exemplary embodiment will be described. The second exemplary embodiment is a case where the image forming apparatus 10 is the ink-jet type. As described above, the ink-jet type is a printing method in which heat or pressure is applied to ink and the ink is sprayed from nozzles.

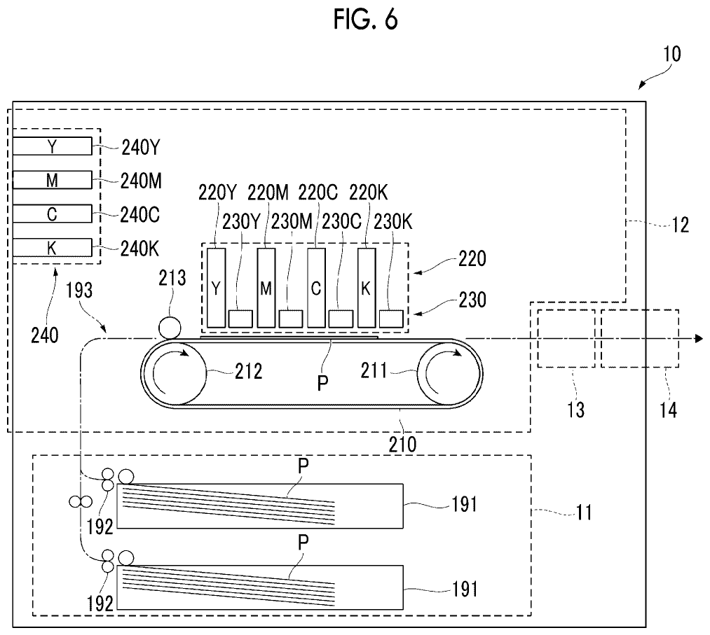

FIG. 6 is a diagram showing an example of a configuration of the image forming apparatus 10 according to the second exemplary embodiment.

As shown in FIG. 6, the image forming apparatus 10 according to the second exemplary embodiment is provided with the paper accommodation section 11, the image forming section 12, the paper transport section 13, and the paper discharge section 14 as in the present exemplary embodiment (see FIG. 1).

In addition, since the paper accommodation section 11, the paper transport section 13, and the paper discharge section 14 in the second exemplary embodiment are the same as the paper accommodation section 11, the paper transport section 13, and the paper discharge section 14 in the first exemplary embodiment, a description thereof may be omitted. In FIG. 6, the control section 15 is not shown.

The image forming section 12 is provided with an endless transport belt 210, an ink jetting head 220, a drying unit 230, and an ink cartridge 240.

The transport belt 210 is stretched between a driving roller 211 and a driven roller 212.

A charging roller 213 is disposed on the upstream side of the transport belt 210. The charging roller 213 is driven, with the transport belt 210 and the paper P pinched between the charging roller 213 and the driven roller 212, and a potential difference occurs between the charging roller 213 and the grounded driven roller 212 to give charge to the paper P. As a result, the paper P is electrostatically attracted to the transport belt 210.

In the second exemplary embodiment, four ink jetting heads 220Y, 220M, 220C, and 220K corresponding to inks of four colors of Y, M, C, and K are provided as the ink jetting head 220 of the image forming section 12.

The ink jetting heads 220Y, 220M, 220C, and 220K are a head for recording a yellow (Y) image, a head for recording a magenta (M) image, a head for recording a cyan (C) image, and a head for recording a black (K) image, respectively. The ink jetting heads 220Y, 220M, 220C, and 220K are arranged, for example, in this order from the upstream side to the downstream side of the transport belt 210.

The ink jetting head 220 is disposed above the transport belt 210 to face a flat portion of the transport belt 210. A region in which the ink jetting head 220 and the transport belt 210 face each other is a region to which ink droplets are jetted from the ink jetting head 220.

An example of the ink jetting head 220 is a long head in which an effective recording region (a region in which nozzles for jetting ink are arranged) is equal to or longer than the width of the paper P (the length of the paper P in a direction perpendicular to the transport direction). In addition, an example of the ink jetting head 220 is a short head that has an effective recording region shorter than the width of the paper P and is a carriage type that is moved in the width direction of the paper P and jets ink.

Examples of an ink-jet method employed by the ink jetting head 220 include a piezoelectric method that uses the vibration pressure of a piezoelectric element and a charge control method that jets ink using an electrostatic attraction force. In addition, an example of the ink-jet method employed by the ink jetting head 220 is an acoustic ink-jet method that converts an electric signal into an acoustic beam, irradiates ink with the acoustic beam, and jets the ink using radiation pressure. Further, an example of the ink-jet method employed by the ink jetting head 220 is a thermal ink-jet method that uses pressure generated by heating ink to form bubbles.

The ink jetting head 220 is, for example, a low-resolution recording head (for example, a 600-dpi recording head) that jets ink droplets in a range of an ink droplet volume of 10 pL or more and 15 pL or less. In addition, the ink jetting head 220 is, for example, a high-resolution recording head (for example, a 1200-dpi recording head) that jets ink droplets in a range of an ink droplet volume of less than 10 pL. dpi means “dots per inch”.

The drying unit 230 is provided with drying units 230Y, 230M, 230C, and 230K corresponding to the four ink jetting heads 220Y, 220M, 220C, and 220K, respectively.

The drying units 230Y, 230M, 230C, and 230K are disposed on the downstream sides of the ink jetting heads 220Y, 220M, 220C, and 220K, respectively.

Examples of the drying unit 230 include a contact-type heating unit and a hot air blowing unit.

In addition, the image forming apparatus 10 according to the second exemplary embodiment includes the drying unit for each ink jetting head of each color. However, the present invention is not limited thereto. The image forming apparatus 10 may have only one drying unit provided on the downstream side of the ink jetting head on the most downstream side. In any case, a configuration in which the paper P is dried in the paper transport section 13 can be adopted.

The ink cartridge 240 supplies an ink of each color to the ink jetting head 220. That is, the ink cartridge 240 is provided with ink cartridges 240Y, 240M, 240C, and 240K corresponding to the four ink jetting heads 220Y, 220M, 220C, and 220K, respectively. The ink cartridges 240Y, 240M, 240C, and 240K are attachable and detachable.

The ink cartridge 240Y is connected to the ink jetting head 220Y through a supply tube (not shown). Similarly, the ink cartridge 240M is connected to the ink jetting head 220M through a supply tube (not shown), the ink cartridge 240C is connected to the ink jetting head 220C through a supply tube (not shown), and the ink cartridge 240K is connected to the ink jetting head 220K through a supply tube (not shown).

The operation of the image forming apparatus 10 according to the second exemplary embodiment will be described.

The paper P fed out from any of the containers 191 of the paper accommodation section 11 is electrostatically attracted to the transport belt 210 by the charging roller 213 and is transported to the lower side of the ink jetting head 220 by the rotation of the transport belt 210. Then, the ink is jetted from the ink jetting head 220 onto the paper P, and an image is recorded. Then, the ink on the paper P is dried by the drying unit 230. Then, the paper P, on which the ink has been dried and the image has been fixed, is transported to the paper transport section 13, is further dried, and is discharged from the paper discharge section 14 to the outside of the apparatus.

Further, the image forming apparatus 10 according to the second exemplary embodiment includes the four ink jetting heads 220Y, 220M, 220C, and 220K. However, the present invention is not limited thereto. For example, the adoption of a form in which the image forming apparatus 10 includes five or more ink jetting heads corresponding to Y, M, C, K, and intermediate colors is considered. In addition, the adoption of a form in which the image forming apparatus 10 includes one ink jetting head and forms an image of only one color is considered.

The exemplary embodiments of the present invention have been described above. However, the technical scope of the present invention is not limited to the above-described exemplary embodiments. In addition, various modifications and alternative configurations are involved in the present invention without departing from the scope of the technical concept of the present invention.

### Supplementary Note

(((1)))

An image forming apparatus comprising:
a transport member that has a transport surface on which paper on which an image forming material is placed is transported and a surface opposite to the transport surface;
a blowing unit that blows cooling air toward the paper being transported on the transport surface of the transport member;
a receiving member that is located on a side of the opposite surface of the transport member and has a receiving surface for receiving the transport member; and
a suction unit that sucks the transport member in a direction of the receiving member by an action of a negative pressure via a through-hole penetrating the receiving member from the receiving surface of the receiving member.
(((2)))

The image forming apparatus according to (((1))),
wherein the receiving member is a heat sink that dissipates heat from the transport member.
(((3)))

The image forming apparatus according to (((2))),
wherein the through-hole penetrating the heat sink is located in a thin portion of the heat sink.
(((4)))

The image forming apparatus according to (((2))),
wherein the through-hole penetrating the heat sink has a circular or elliptical cross section.
(((5)))

The image forming apparatus according to (((1))),
wherein the blowing unit blows air toward the paper being transported in a direction opposite to a direction in which the transport member transports the paper.
(((6)))

The image forming apparatus according to (((5))),
wherein the blowing unit blows the air in the opposite direction at an angle of 30 degrees or more with respect to the transport surface of the transport member.
(((7)))

The image forming apparatus according to (((5))),
wherein the blowing unit blows the air in the opposite direction at an angle of 60 degrees or less with respect to the transport surface of the transport member.
(((8)))

The image forming apparatus according to any one of (((1))) to (((7))),
wherein a region in which a plurality of through-holes are located is narrower than a region of the transport surface, to which the blowing unit blows the air, in the direction in which the transport member transports the paper.
(((9)))

The image forming apparatus according to any one of (((1))) to (((8))),
wherein a plurality of through-holes are arranged to be symmetric with respect to a direction intersecting the direction in which the transport member transports the paper.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a transport member that has a transport surface on which paper on which an image forming material is placed is transported and a surface opposite to the transport surface;
a blowing unit that blows cooling air toward the paper being transported on the transport surface of the transport member;
a receiving member that is located on a side of the opposite surface of the transport member and has a receiving surface for receiving the transport member; and
a suction unit that sucks the transport member in a direction of the receiving member by an action of a negative pressure via a through-hole penetrating the receiving member from the receiving surface of the receiving member.

2. The image forming apparatus according to claim 1,
wherein the receiving member is a heat sink that dissipates heat from the transport member.

3. The image forming apparatus according to claim 2,
wherein the through-hole penetrating the heat sink is located in a thin portion of the heat sink.

4. The image forming apparatus according to claim 2,
wherein the through-hole penetrating the heat sink has a circular or elliptical cross section.

5. The image forming apparatus according to claim 1,
wherein the blowing unit blows air toward the paper being transported in a direction opposite to a direction in which the transport member transports the paper.

6. The image forming apparatus according to claim 5,
wherein the blowing unit blows the air in the opposite direction at an angle of 30 degrees or more with respect to the transport surface of the transport member.

7. The image forming apparatus according to claim 5,
wherein the blowing unit blows the air in the opposite direction at an angle of 60 degrees or less with respect to the transport surface of the transport member.

8. The image forming apparatus according to claim 1,
wherein a region in which a plurality of through-holes are located is narrower than a region of the transport surface, to which the blowing unit blows the air, in the direction in which the transport member transports the paper.

9. The image forming apparatus according to claim 1,
wherein a plurality of through-holes are arranged to be symmetric with respect to a direction intersecting the direction in which the transport member transports the paper.

10. An image forming apparatus comprising:
a transport member that has a transport surface on which paper on which an image forming material is placed is transported and a surface opposite to the transport surface;
means for blowing cooling air toward the paper being transported on the transport surface of the transport member;
a receiving member that is located on a side of the opposite surface of the transport member and has a receiving surface for receiving the transport member; and
means for sucking the transport member in a direction of the receiving member by an action of a negative pressure via a through-hole penetrating the receiving member from the receiving surface of the receiving member.
